(19) United States
(12) Patent Application Publication
(10) Pub. No.: US 2026/0343592 A1
(43) Pub. Date: Oct. 29, 2026

(54) MESSAGE RETRANSMISSION IN CONTENTION-BASED RANDOM ACCESS PROCEDURE

(71) Applicant: QUALCOMM Incorporated, San Diego, CA (US)

(72) Inventors: Jing LEI, San Diego, CA (US); Jing SUN, San Diego, CA (US); Linhai HE, San Diego, CA (US)

(21) Appl. No.: 19/190,492

(22) Filed: Apr. 25, 2025

(51) Int. Cl. H04W 74/02; H04L 1/18; H04W 74/00

(52) U.S. Cl. CPC H04W 74/02; H04L 1/18; H04W 74/006

(57) ABSTRACT

Various aspects of the present disclosure generally relate to wireless communication. In some aspects, a user equipment (UE) may transmit, to a network node, a message, related to a contention-based random access procedure, according to a schedule indicated by a random access response (RAR). The UE may receive, from the network node, an indication of an unsuccessful decoding of the message, wherein the indication includes an uplink (UL) grant for retransmission of the message. The UE may retransmit, to the network node, the message, according to the UL grant. Numerous other aspects are described.

### FIELD OF THE DISCLOSURE

Aspects of the present disclosure generally relate to wireless communication and specifically relate to techniques, apparatuses, and methods associated with message retransmission in contention-based random access procedure.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a wireless network, contention-based random access (CBRA) is an operation mode that enables a user equipment (UE) to initiate communication with a network node without prior scheduling. The UE may utilize CBRA in connection with one or more radio resource control (RRC) states, including an idle state, an inactive state, or a connected state. A random access procedure (e.g., a CBRA procedure) may include a series of messages exchanged between the UE and the network node, including a preamble, a random access response (RAR), and subsequent uplink and downlink transmissions.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to transmit, to a network node, a message, related to a contention-based random access (CBRA) procedure, according to a schedule indicated by a random access response (RAR). The processing system may be configured to cause the UE to receive, from the network node, an indication of an unsuccessful decoding of the message, wherein the indication includes an uplink (UL) grant for retransmission of the message. The processing system may be configured to cause the UE to retransmit, to the network node, the message, according to the UL grant.

Some aspects described herein relate to a network node. The network node may include a processing system. The processing system may include one or more processors and one or more code-storing memories coupled with the one or more processors. The processing system may be configured to cause the network node to receive, from a UE, a message, related to a CBRA procedure. The processing system may be configured to cause the network node to transmit, to the UE, an indication of an unsuccessful decoding of the message, wherein the indication includes a UL grant for retransmission of the message. The processing system may be configured to cause the network node to receive, from the UE, a retransmission of the message, according to the UL grant.

Some aspects described herein relate to a method of wireless communication performed by a UE. The method may include transmitting, to a network node, a message, related to a CBRA procedure, according to a schedule indicated by an RAR. The method may include receiving, from the network node, an indication of an unsuccessful decoding of the message, wherein the indication includes a UL grant for retransmission of the message. The method may include retransmitting, to the network node, the message, according to the UL grant.

Some aspects described herein relate to a method of wireless communication performed by a network node. The method may include receiving, from a UE, a message, related to a CBRA procedure. The method may include transmitting, to the UE, an indication of an unsuccessful decoding of the message, wherein the indication includes a UL grant for retransmission of the message. The method may include receiving, from the UE, a retransmission of the message, according to the UL grant.

Some aspects described herein relate to a non-transitory computer-readable medium that stores a set of instructions for wireless communication by a UE. The set of instructions, when executed by one or more processors of the UE, may cause the UE to transmit, to a network node, a message, related to a CBRA procedure, according to a schedule indicated by an RAR. The set of instructions, when executed by one or more processors of the UE, may cause the UE to receive, from the network node, an indication of an unsuccessful decoding of the message, wherein the indication includes a UL grant for retransmission of the message. The set of instructions, when executed by one or more processors of the UE, may cause the UE to retransmit, to the network node, the message, according to the UL grant.

Some aspects described herein relate to a non-transitory computer-readable medium that stores a set of instructions for wireless communication by a network node. The set of instructions, when executed by one or more processors of the network node, may cause the network node to receive, from a UE, a message, related to a CBRA procedure. The set of instructions, when executed by one or more processors of the network node, may cause the network node to transmit, to the UE, an indication of an unsuccessful decoding of the message, wherein the indication includes a UL grant for retransmission of the message. The set of instructions, when executed by one or more processors of the network node, may cause the network node to receive, from the UE, a retransmission of the message, according to the UL grant.

Some aspects described herein relate to an apparatus for wireless communication. The apparatus may include means for transmitting, to a network node, a message, related to a CBRA procedure, according to a schedule indicated by an RAR. The apparatus may include means for receiving, from the network node, an indication of an unsuccessful decoding of the message, wherein the indication includes a UL grant for retransmission of the message. The apparatus may include means for retransmitting, to the network node, the message, according to the UL grant.

Some aspects described herein relate to an apparatus for wireless communication. The apparatus may include means for receiving, from a UE, a message, related to a CBRA procedure. The apparatus may include means for transmitting, to the UE, an indication of an unsuccessful decoding of the message, wherein the indication includes a UL grant for retransmission of the message. The apparatus may include means for receiving, from the UE, a retransmission of the message, according to the UL grant.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a four-step random access procedure.

FIG. 3 is a diagram illustrating an example of a two-step random access procedure.

FIGS. 4A-4B are diagrams illustrating example of unsuccessful random access channel procedures.

FIGS. 5A-5E are diagrams illustrating an example associated with message retransmission in content-based random access procedures.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIGS. 8-9 are diagrams of example apparatuses for wireless communication.

### DETAILED DESCRIPTION

In a wireless network, contention-based random access (CBRA) is an operation mode that enables a user equipment (UE) to initiate communication with a network node without prior scheduling. The UE may utilize CBRA in connection with one or more radio resource control (RRC) states, including an idle state, an inactive state, or a connected state. For example, a four-step random access procedure (e.g., a CBRA procedure) may include a series of steps, including the transmission, from the network node, of a preamble (e.g., a first message), reception, at the UE, of a random access response (RAR) (e.g., a second message), and subsequent transmission, from the UE, of a scheduling request (e.g., a third message). These steps enable initial communication between the UE and the network to be established or re-established.

However, in some examples, one or more transmissions in a CBRA procedure may be unsuccessfully decoded by the network node (e.g., due to coverage limitations or network interference, among other examples). When the network node fails to decode a transmission (e.g., a third transmission or a similar transmission scheduled by the network node), the network node may resend an uplink (UL) grant for the UE to retransmit the unsuccessfully decoded message. In some examples, scheduling for message retransmission may be through downlink control information (DCI). However, such an approach may be limited by the payload size of the DCI and may not provide sufficient reliability, especially in coverage-limited scenarios.

Additionally, in some examples, the UE may not be configured to monitor an initial RAR window related to the initial RAR message or the UE may not be configured to monitor further physical downlink control channel (PDCCH) signals related to the UE-associated radio network temporary identifier (RNTI). As a result, where the UE does not monitor these channels (e.g., after the UE sends the message that is unsuccessfully decoded at the network node), the UE will be unable to receive the subsequent UL grant that is transmitted from the network, thereby resulting in the UE failing to retransmit the unsuccessfully decoded message. This inconsistency between the UE and the network may compromise energy efficiency, resource utilization efficiency, and latency performance during the CBRA procedure.

Various aspects relate generally to configurations for message retransmission in CBRA procedures. Some aspects more specifically relate to improving the reliability and efficiency of message retransmissions by enabling the UE to monitor for different types of UL grants and adjusting the monitoring period for these grants. In some aspects, if the initial message transmission is unsuccessfully decoded by the network node, the network node may resend the UL grant to enable the UE to retransmit the initial message. This UL grant can be retransmitted either in an RAR only or in both DCI and RAR (e.g., a portion of the UL grant may be transmitted in DCI and a portion of the UL grant may be transmitted in an RAR). Additionally, the bit size of the DCI for the UL grant retransmission may be aligned with the bit size for a scheduling PDCCH for RAR retransmission in order to reduce UE complexity.

In some aspects, the UE can be configured to monitor UL grants with different formats in the same or different time windows, which may fully or partially overlap. Such a configuration can extend the UE's monitoring beyond an initial RAR window (e.g., associated with receipt of the initial RAR), enabling the UE to receive retransmission UL grants more reliably. The starting and ending points of these monitoring windows may also be adjusted according to one or more parameters or thresholds. For example, a starting or ending point of a monitoring window may align with, or be offset from, a contention resolution (CR) timer related to the CBRA procedure.

In some aspects, the RAR retransmission may be adapted to include different scheduling information for the UE's retransmission of the initial message (e.g., the unsuccessfully decoded message). For example, the RAR retransmission may include adaptations to a radio resource allocation, a modulation and coding scheme (MCS), repetition levels, frequency hopping information, transmit power information, (e.g., power ramping or transmit power control information), spatial filters, transport block sizes (TBSs) or other aspects that may improve coverage and reliability, among other examples. In some aspects, the network node may disable a new data indicator (NDI) field related to the UE's retransmission of the initial message in order to ensure consistency in the TBS for the retransmission of the initial message.

Particular aspects of the subject matter described in this disclosure can be implemented to realize one or more of the following potential advantages. In some examples, where the UE is configured to monitor multiple UL grant formats and to adapt the associated monitoring period, the reliability of message retransmission may be improved in CBRA procedures (e.g., in coverage-limited scenarios, in scenarios of relatively high network interference levels, or the like). In this way, the UE and the network node may reduce the likelihood of failed message retransmissions and subsequent delays in the CBRA procedure, which may conserve processing resources and network resources. Additionally, by aligning the DCI size and configuring overlapping monitoring windows, the configuration complexity associated with monitoring for a UL grant may be reduced, leading to more efficient resource utilization and lower power consumption. Furthermore, by enhancing the contents of RAR retransmissions and indicating monitoring configurations for the UE, the overall latency performance and communication efficiency during CBRA procedures may be improved.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

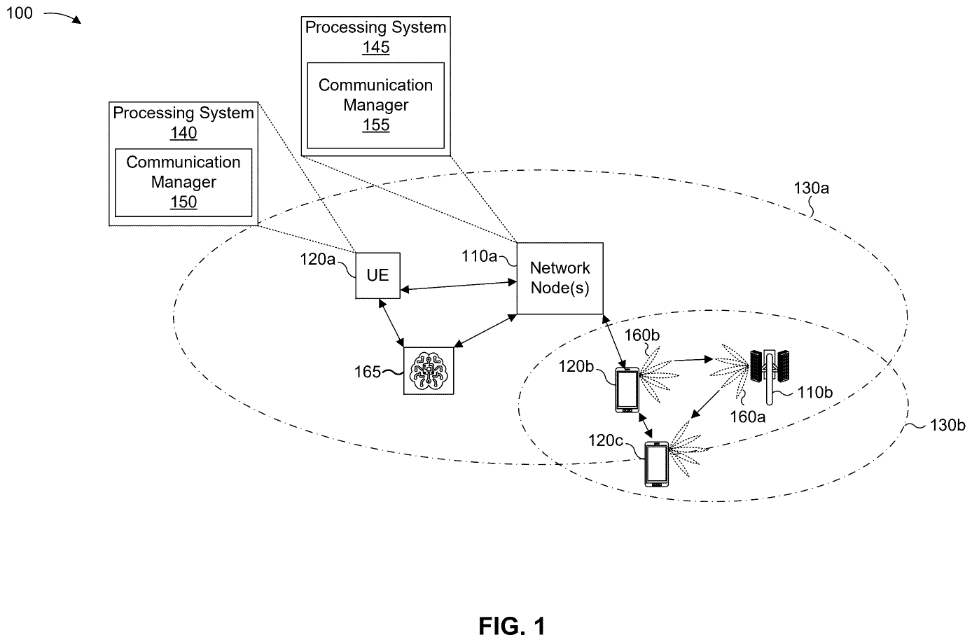

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR 2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR 1 is greater than 6 GHz, FR 1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and a UL. “Downlink” (or “DL”) refers to a communication direction from a network node 110 to a UE 120, and “uplink” (or “UL”) refers to a communication direction from a UE 120 to a network node 110. Downlink and UL resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both a UL BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, NDIs, among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, a UL signal may include a reference signal, control information, or data. For example, UL reference signals include a sounding reference signal (SRS), a PTRS, and a DMRS, among other examples. A UL signal carrying control information or data may be transmitted via a UL channel. A UL channel may include one or more control channels for transmitting control information and one or more data channels for transmitting data. UL reference signals may be transmitted in addition to, or multiplexed with, UL control channel communications or UL data channel communications. A UL control channel may be specifically used to transmit UL control information (UCI) from a UE 120 to a network node 110. A UL data channel may be used to transmit UL data (for example, user data associated with a UE 120) from a UE 120 to a network node 110. UL control channels may include physical UL control channels (PUCCHs), and UL data channels may include physical UL shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), UL power control information (for example, a UL TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or a UL signal. For example, the network node 110 may select an MCS for a downlink signal in accordance with UCI received from the UE 120 or may transmit, to the UE 120, an indication of an MCS to be applied for a UL signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or UL transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or UL signal measurements. The network node 110a or the UE 120a may transmit the processed downlink or UL signals, respectively, via one or more antennas.

The network node 110a or the UE 120a may receive UL signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received UL or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or UL signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or UL signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may transmit, to a network node 110, a message, related to a CBRA procedure, according to a schedule indicated by an RAR; receive, from the network node 110, an indication of an unsuccessful decoding of the message, wherein the indication includes a UL grant for retransmission of the message; and retransmit, to the network node 110, the message, according to the UL grant. Additionally, or alternatively, the communication manager 150 may perform one or more other operations described herein.

In some aspects, the network node 110 may include a communication manager 155. As described in more detail elsewhere herein, the communication manager 155 may receive, from a UE 120, a message, related to a CBRA procedure; transmit, to the UE 120, an indication of an unsuccessful decoding of the message, wherein the indication includes a UL grant for retransmission of the message; and receive, from the UE 120, a retransmission of the message, according to the UL grant. Additionally, or alternatively, the communication manager 155 may perform one or more other operations described herein.

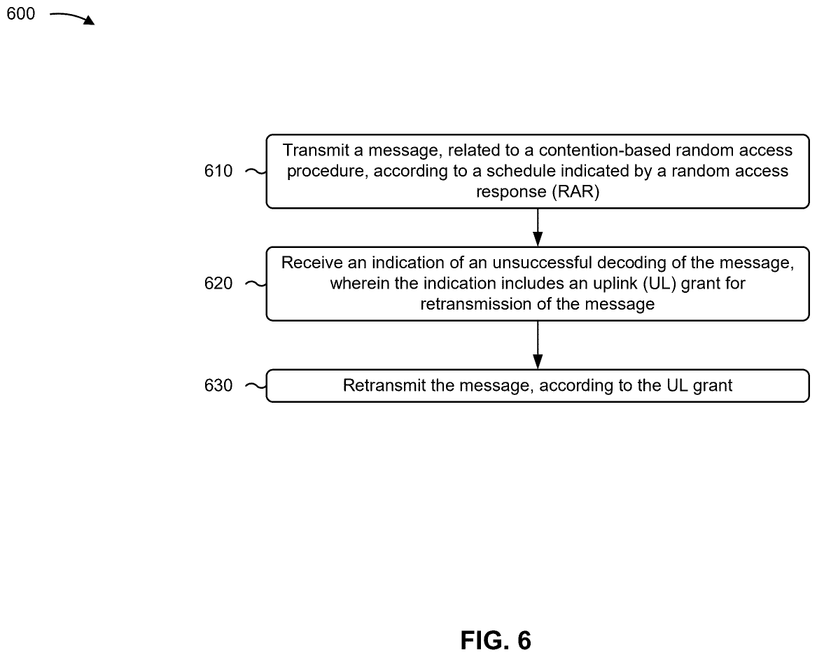

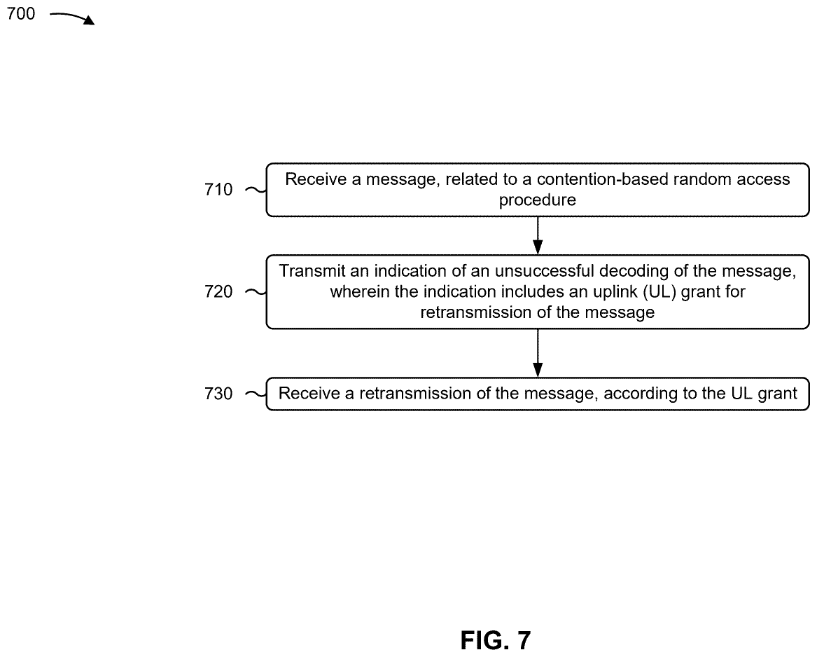

The network node 110, the processing system 145 of the network node 110, the UE 120, the processing system 140 of the UE 120, or any other component(s) of FIG. 1 may implement one or more techniques or perform one or more operations associated with message retransmission in CBRA procedures, as described in more detail elsewhere herein. For example, the processing system 145 of the network node 110, or the processing system 140 of the UE 120 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

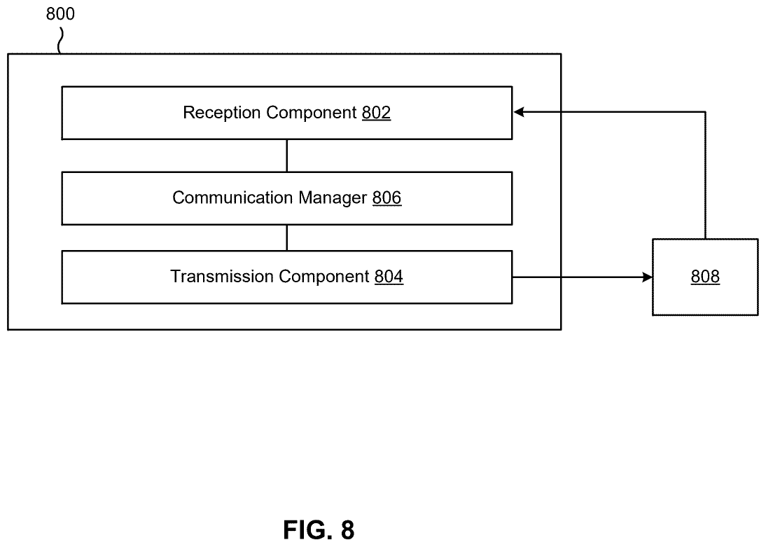

In some aspects, the UE 120 includes means for transmitting, to a network node 110, a message, related to a CBRA procedure, according to a schedule indicated by an RAR; means for receiving, from the network node 110, an indication of an unsuccessful decoding of the message, wherein the indication includes a UL grant for retransmission of the message; or means for retransmitting, to the network node 110, the message, according to the UL grant. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

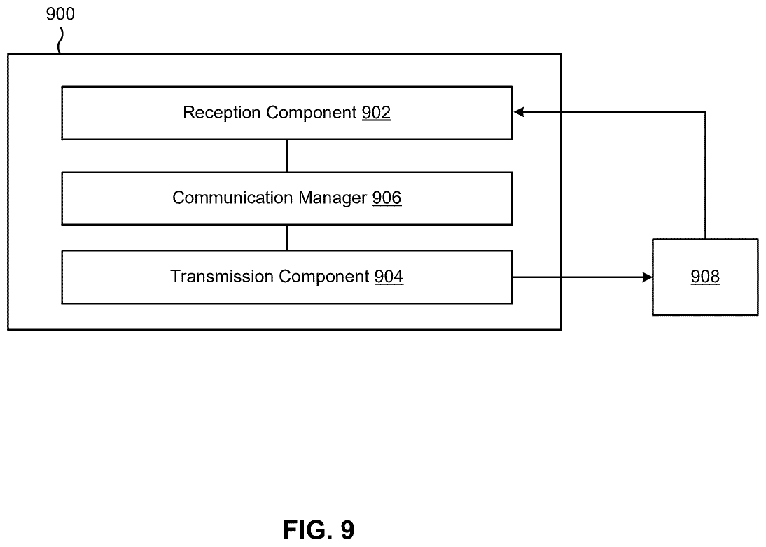

In some aspects, the network node 110 includes means for receiving, from a UE 120, a message, related to a CBRA procedure; means for transmitting, to the UE 120, an indication of an unsuccessful decoding of the message, wherein the indication includes a UL grant for retransmission of the message; or means for receiving, from the UE 120, a retransmission of the message, according to the UL grant. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

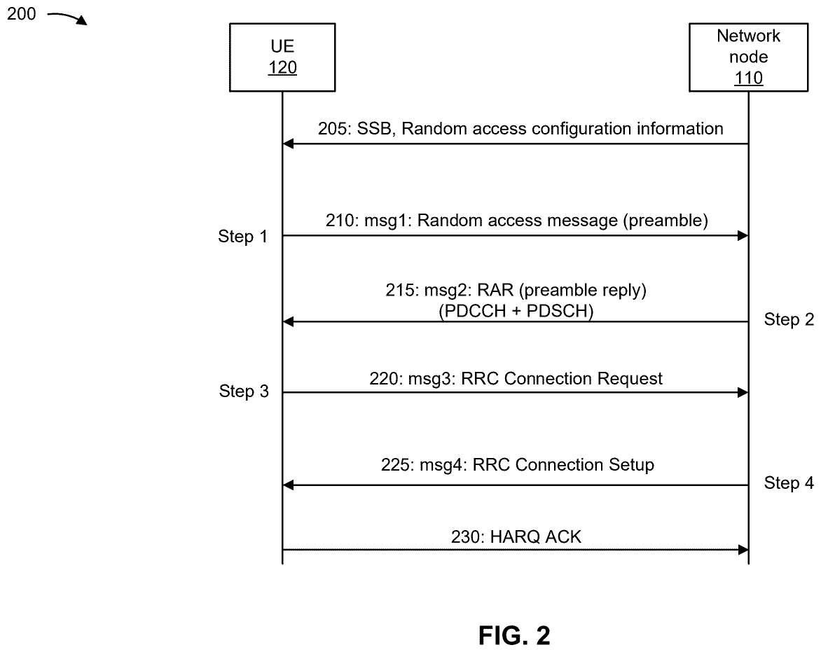

FIG. 2 is a diagram illustrating an example of a four-step random access procedure. As shown in FIG. 2, a network node 110 and a UE 120 may communicate with one another to perform the four-step random access procedure.

As shown by reference number 205, the network node 110 may transmit, and the UE 120 may receive, one or more SSBs and random access configuration information. In some aspects, the random access configuration information may be transmitted in or indicated by system information (e.g., in one or more system information blocks (SIBs)) or an SSB, such as for CBRA. Additionally, or alternatively, the random access configuration information may be transmitted in an RRC message or a PDCCH order message that triggers a random access channel (RACH) procedure, such as for contention-free random access. The random access configuration information may include one or more parameters to be used in the random access procedure, such as one or more parameters for transmitting an RAM or one or more parameters for receiving an RAR.

As shown by reference number 210, the UE 120 may transmit an RAM, which may include a preamble (sometimes referred to as a random access preamble, a PRACH preamble, or an RAM preamble). The message that includes the preamble may be referred to as a message 1, msg1, MSG1, a first message, or an initial message in a four-step random access procedure. The random access message may include a random access preamble identifier.

As shown by reference number 215, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3). For example, the RAR may indicate a UL grant to be used by the UE 120 to transmit the message 3.

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 220, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 225, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or CR information. As shown by reference number 230, if the UE 120 successfully receives the RRC connection setup message, the UE 120 may transmit a HARQ ACK.

As indicated above, FIG. 2 is provided as an example. Other examples may differ from what is described with regard to FIG. 2.

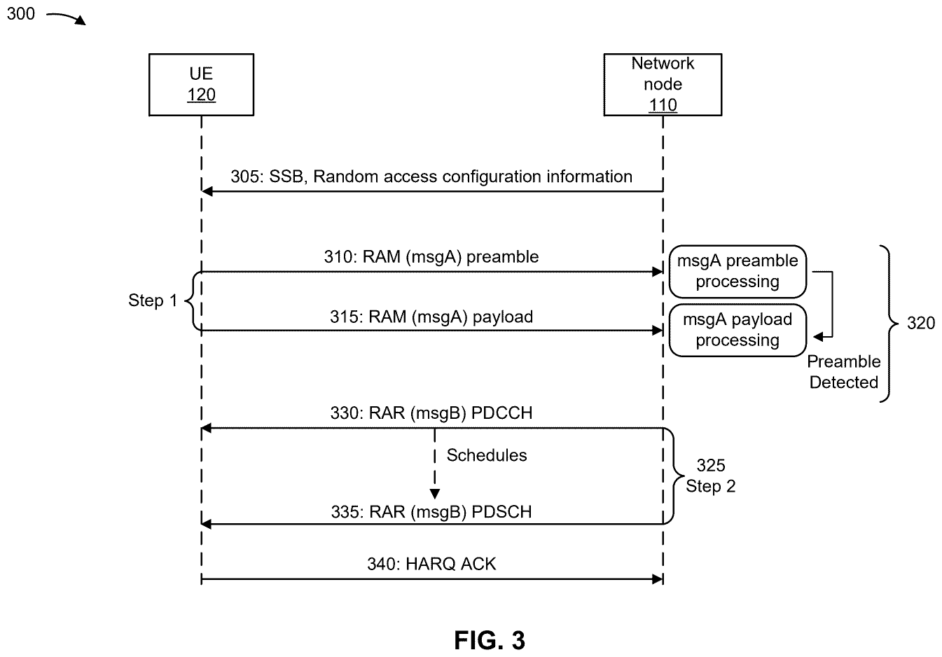

FIG. 3 is a diagram illustrating an example 300 of a two-step random access procedure. As shown in FIG. 3, a network node 110 and a UE 120 may communicate with one another to perform the two-step random access procedure.

As shown by reference number 305, the network node 110 may transmit, and the UE 120 may receive, one or more SSBs and random access configuration information. In some aspects, the random access configuration information may be transmitted in or indicated by system information (e.g., in one or more SIBs) or an SSB, such as for CBRA. Additionally, or alternatively, the random access configuration information may be transmitted in an RRC message or a PDCCH order message that triggers a RACH procedure, such as for contention-free random access. The random access configuration information may include one or more parameters to be used in the two-step random access procedure, such as one or more parameters for transmitting a random access message (RAM) or receiving an RAR to the RAM.

As shown by reference number 310, the UE 120 may transmit, and the network node 110 may receive, an RAM preamble. As shown by reference number 315, the UE 120 may transmit, and the network node 110 may receive, an RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, or a PUSCH transmission).

As shown by reference number 320, the network node 110 may receive the RAM preamble transmitted by the UE 120. If the network node 110 successfully receives and decodes the RAM preamble, the network node 110 may then receive and decode the RAM payload.

As shown by reference number 325, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, CR information, UL grants, or other configuration information for further communications.

As shown by reference number 330, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 335, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 340, if the UE 120 successfully receives the RAR, the UE 120 may transmit a HARQ ACK.

As indicated above, FIG. 3 is provided as an example. Other examples may differ from what is described with regard to FIG. 3.

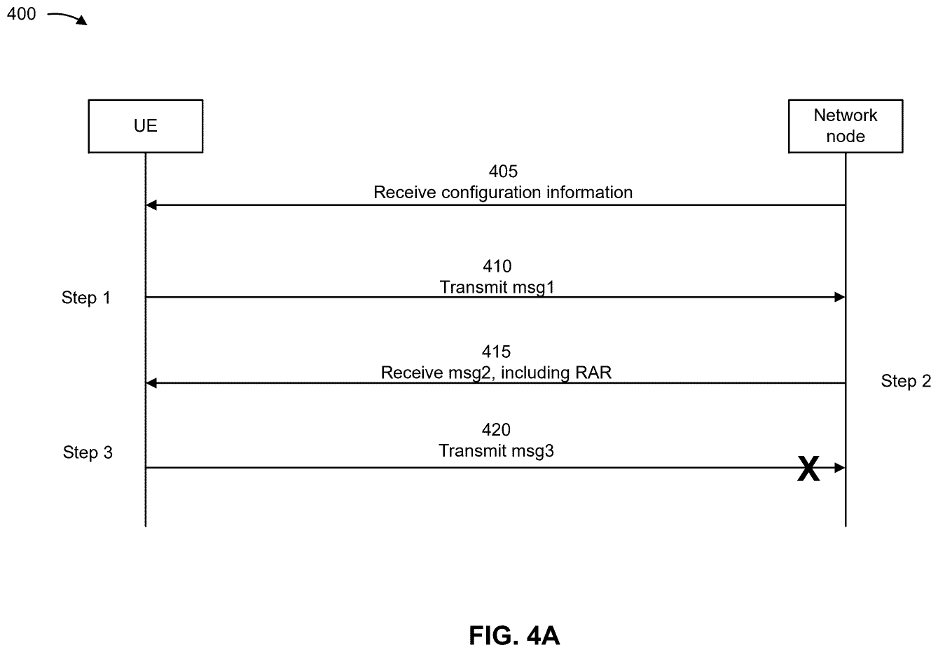

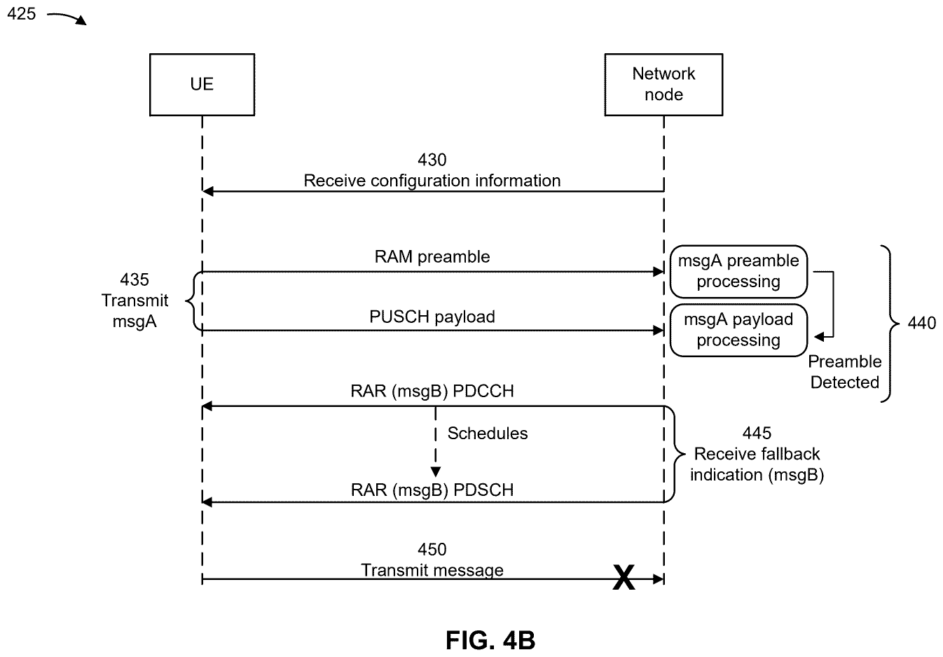

FIGS. 4A-4B are diagrams illustrating example 400 and 425 of unsuccessful RACH procedures. As shown in FIGS. 4A-4B, a network node (e.g., network node 110) and a UE (e.g., UE 120) may communicate with one another.

As shown in FIG. 4A, and reference number 405, a network node may transmit, and a UE may receive, configuration information. For example, the UE may receive configuration information related to a CBRA procedure. In some examples, the configuration information may include parameters for transmitting an RAM or receiving an RAR to the RAM. In some examples, receiving the configuration information may include the UE receiving system information from the network, which configures the CBRA procedure. For example, the system information may provide information related to frequency and timing parameters for the CBRA procedure. Additionally, or alternatively, receiving the configuration information may include the UE obtaining configuration parameters, via a broadcast message, for performing the CBRA. For example, the broadcast message may be periodically transmitted by the network node in order to provide updated CBRA parameters. Additionally, or alternatively, receiving the configuration information may include the UE being provisioned with initial access parameters, including timing and frequency information for the CBRA. For example, these parameters may be provisioned to the UE during its initial registration with the network.

As shown by reference number 410, the UE may transmit, and the network node may receive, a first message (e.g., a msg1). For example, the UE may transmit the first message, which may include a preamble, to initiate the CBRA procedure. The preamble may be referred to as a random access preamble, a PRACH preamble, or an RAM preamble. In some examples, transmitting the msg1 may include the UE sending an initial access request to the network node. For example, the initial access request may be used to gain access to the network resources. Additionally, or alternatively, transmitting the msg1 may include the UE initiating the CBRA procedure by transmitting a sequence of symbols as a preamble. For example, the sequence of symbols may be designed in order to be easily detected by the network node. Additionally, or alternatively, transmitting the msg1 may include the UE sending a RACH request message to obtain UL synchronization. For example, the RACH request message may enable the UE to synchronize the UE's UL transmissions with the network node.

As shown by reference number 415, the network node may transmit, and the UE may receive, a second message (e.g., a msg2), including an RAR. For example, the RAR may indicate the detected random access preamble identifier and may include a resource allocation for transmitting a third message (e.g., a msg3). In some examples, receiving the msg2 may include the UE receiving a response from the network node indicating the allocation of resources for further communication. For example, the response may provide the UE with resources to transmit a next message. Additionally, or alternatively, the msg2 may include timing advance and UL grant information. For example, the timing advance information may be used to adjust the UE's UL transmission timing. Additionally, or alternatively, the msg2 may include a detected preamble identifier and assigned UL resources. For example, the control message may provide the UE with the specific resources to use for the UE's next transmission.

As shown by reference number 420, the UE may transmit a msg3, and the network node may fail to successfully decode the msg3 or the network node may fail to receive the msg3. For example, the UE may transmit the msg3, which may include an RRC connection request. The RRC connection request may include a UE identifier, UCI, or a PUSCH transmission. In some examples, the decoding or reception of the msg3 (e.g., at the network node) may be unsuccessful due to coverage limitations or network interference. In some examples, the msg3 may include a connection request message to the network node. For example, the connection request message may be used to establish a communication link with the network. Additionally, or alternatively, the msg3 may include UL data, including an identifier and control information related to the UE, to establish a connection between the UE and the network node. For example, the UL data may be intended to provide the network node with information to enable the network node to identify and communicate with the UE. Additionally, or alternatively, the msg3 may include information related to the UE's identity and related information to enable the CBRA procedure to proceed. For example, the msg3 may include critical information required for the network to authenticate and establish a connection with the UE.

As a result, where the network node fails to successfully decode the msg3, the UE may not receive the acknowledgment or further instructions to proceed with the random access procedure. This failure can lead to increased latency where the UE restarts the random access procedure, thereby consuming additional network resources and potentially causing delays in establishing a stable communication link. Additionally, the failure to decode the msg3 can result in inefficient utilization of network resources and reduced overall system performance, particularly in scenarios with high interference or coverage limitations.

As shown in FIG. 4B, and by reference number 430, a network node may transmit, and a UE may receive, configuration information. For example, the UE may receive configuration information related to a CBRA procedure. In some examples, the configuration information may include parameters for transmitting an RAM or receiving an RAR in response to the RAM. In some examples, the configuration information may include system information, from the network node, that configures the CBRA procedure. For example, the system information may provide information related to frequency and timing parameters for the CBRA procedure. Additionally, or alternatively, receiving the configuration information may include the UE obtaining configuration parameters, via a broadcast message, for performing the CBRA. For example, the broadcast message may be periodically transmitted by the network node in order to provide updated CBRA parameters.

Additionally, or alternatively, receiving the configuration information may include the UE being provisioned with initial access parameters, including timing and frequency information for the CBRA. For example, these parameters may be provisioned to the UE during its initial registration with the network. Additionally, or alternatively, receiving the configuration information may include the UE receiving configuration information related to multiple access procedures, including CBRA and other random access methods. For example, this may enable the UE to be adapted to different network scenarios. Additionally, or alternatively, receiving the configuration information may include the UE receiving configuration information through dedicated signaling or control channels instead of broadcast messages. For example, where the network node provides configuration information through dedicated signaling or control methods, the reliability and timeliness of receiving the configuration information may be improved.

As shown by reference number 435, the UE may transmit a msgA. For example, the UE may transmit the msgA, which may include an RAM preamble and a PUSCH payload. In some aspects, the RAM preamble may be referred to as a message A preamble, a msgA preamble, a preamble, or a PRACH preamble, and the RAM payload may be referred to as a message A payload, a msgA payload, or a payload. In some examples, transmitting the msgA may include the UE sending an initial access request to the network node. For example, the initial access request may be used to gain access to the network resources. Additionally, or alternatively, transmitting the msgA may include the UE initiating the CBRA procedure by transmitting a sequence of symbols as a preamble. For example, the sequence of symbols may be designed in order to be easily detected by the network node. Additionally, or alternatively, transmitting the msgA may include the UE sending a RACH request message to obtain UL synchronization. For example, the RACH request message may enable the UE to synchronize the UE's UL transmissions with the network node.

Additionally, or alternatively, transmitting the msgA may include the UE transmitting a msgA comprising different combinations of preamble and payload, such as a standalone preamble followed by a separate payload transmission. For example, this method can be used to adapt to different network configurations and requirements. Additionally, or alternatively, transmitting the msgA may include the UE transmitting a msgA including additional information such as UE capabilities, quality of service (QoS) requirements, or security credentials. For example, this additional information can help the network node optimize resource allocation and security measures.

Additionally, or alternatively, transmitting the msgA may include the preamble being designed using various modulation and coding schemes to enhance detection probability under different network conditions. For example, such an approach may increase the likelihood of successful communication in varying signal environments. Additionally, or alternatively, transmitting the msgA may include the payload transmitted in msgA including initial access data such as a UE identity, an initial bandwidth request, or context information from previous connections. For example, inclusion of such initial access data may enable the network node to effectively manage the UE's access and resource allocation. Additionally, or alternatively, transmitting the msgA may include using adaptive transmission techniques based on real-time feedback from the network node.

As shown by reference number 440, the network node may detect the preamble received in the msgA. For example, the network node may receive and process the preamble included in msgA to initiate the CBRA procedure. The preamble may be referred to as a random access preamble, a PRACH preamble, or an RAM preamble. In some examples, detecting the preamble may include the network node receiving and decoding the preamble to identify the UE's initial transmission. For example, the network node may perform signal processing operations to detect the presence of the preamble and to determine the timing and frequency parameters required for further communication with the UE. Additionally, or alternatively, detecting the preamble may include the network node identifying the preamble sequence transmitted by the UE and establishing initial synchronization for the CBRA procedure. Additionally, or alternatively, detecting the preamble may include the network node utilizing advanced signal processing techniques such as beamforming, diversity combining, or multi-path propagation estimation to detect the preamble. For example, these techniques can significantly enhance the detection accuracy and reliability.

Additionally, or alternatively, detecting the preamble may include the network node cross-referencing with a database of known preamble sequences to improve accuracy. For example, such cross-referencing may enable the network node to distinguish the correct preamble from potential noise or interference. Additionally, or alternatively, detecting the preamble may include the network node performing simultaneous detection of multiple preambles transmitted by different UEs to handle high-load scenarios. For example, such a capability may be utilized in dense network environments where multiple UEs may be attempting access simultaneously. Additionally, or alternatively, detecting the preamble may include the network node adjusting its detection parameters dynamically based on current interference levels, network traffic, or environmental conditions. Additionally, or alternatively, detecting the preamble may include preamble detection being enhanced by using machine learning algorithms that predict the best detection parameters based on historical data. For example, this method may utilize historical patterns to improve detection efficiency and accuracy.

As shown by reference number 445, the network node may transmit, and the UE may receive, a fallback indication. For example, the network node may transmit a fallback indication to the UE if the initial transmission of the PUSCH payload in msgA is not successfully received or decoded. The fallback indication may be referred to as message B, msgB, or a second message in a two-step random access procedure. In some examples, receiving the fallback indication may include the UE receiving an RAR that indicates the detected preamble identifier and includes a resource allocation for retransmitting the PUSCH payload. For example, the network node may transmit the fallback indication to inform the UE that the initial payload transmission was not successful and to provide the resources for retransmission. Additionally, or alternatively, receiving the fallback indication may include the UE receiving scheduling information for retransmitting the PUSCH payload, including timing advance and UL grant information. Additionally, or alternatively, the msgB may include additional signaling for fallback scenarios such as simultaneous multi-UE retransmission coordination or prioritized retransmission scheduling. Additionally, or alternatively, receiving the fallback indication may include the fallback indication being sent via different channels, such as via DCI or dedicated fallback signaling channels.

As shown by reference number 450, the UE may transmit a message (e.g., a scheduled transmission), and the network node may fail to successfully decode the message or may fail to receive the message. For example, the UE may retransmit the PUSCH payload according to the fallback indication received from the network node. In some examples, the retransmitted message may include the same payload information as the initial transmission in msgA, but may be scheduled according to the resource allocation provided in the fallback indication.

As a result, where the network node fails to successfully decode the message transmitted by the UE, the UE may not receive the acknowledgment or further instructions to proceed with the random access procedure. This failure may result in increased latency where the UE may restart the random access procedure, thereby consuming additional network resources and potentially causing delays in establishing a communication link between the UE and the network node. Additionally, the failure to decode the message can result in inefficient utilization of network resources and reduced overall system performance, particularly in scenarios with high interference or coverage limitations. The inability to successfully decode the message may also lead to a higher probability of connection drops or failed access attempts, which can degrade the user experience and network reliability.

Furthermore, where the UE does not monitor the RAR response after transmitting the msg3 or the message scheduled in response to the msgB, the UE may not receive a UL grant that is retransmitted, by the network node, in the RAR. For example, where the UE stops monitoring a PDCCH addressed to the random access-RNTI (RA-RNTI) or msgB-RNTI after transmitting msg3 or the message in response to msgB, respectively, the UE will be unable to receive a UL grant that is retransmitted in the RAR. As a result, the UE will be unable to retransmit the msg3 or the message scheduled in response to the msgB.

Such inconsistency and ambiguity between the UE and the network node may compromise several aspects of the CBRA procedure. For example, where the UE restarts the random access procedure, both the network node and the UE may engage in increased power consumption. Additionally, spectral efficiency may be reduced, as the network resources allocated for the initial transmission and potential retransmissions are wasted. Furthermore, latency performance of the CBRA procedure is also degraded, as the failure to decode the msg3 or the final message (e.g., in response to the msgB) may result in delays in establishing a communication link between the UE and the network node.

As indicated above, FIGS. 4A-4B are provided as examples. Other examples may differ from what is described with respect to FIGS. 4A-4B.

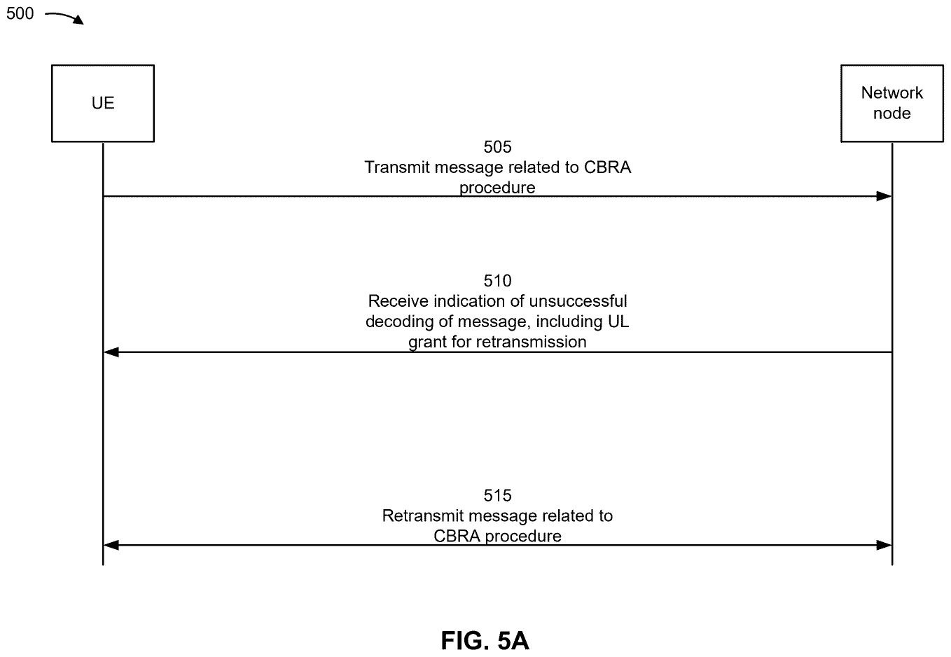

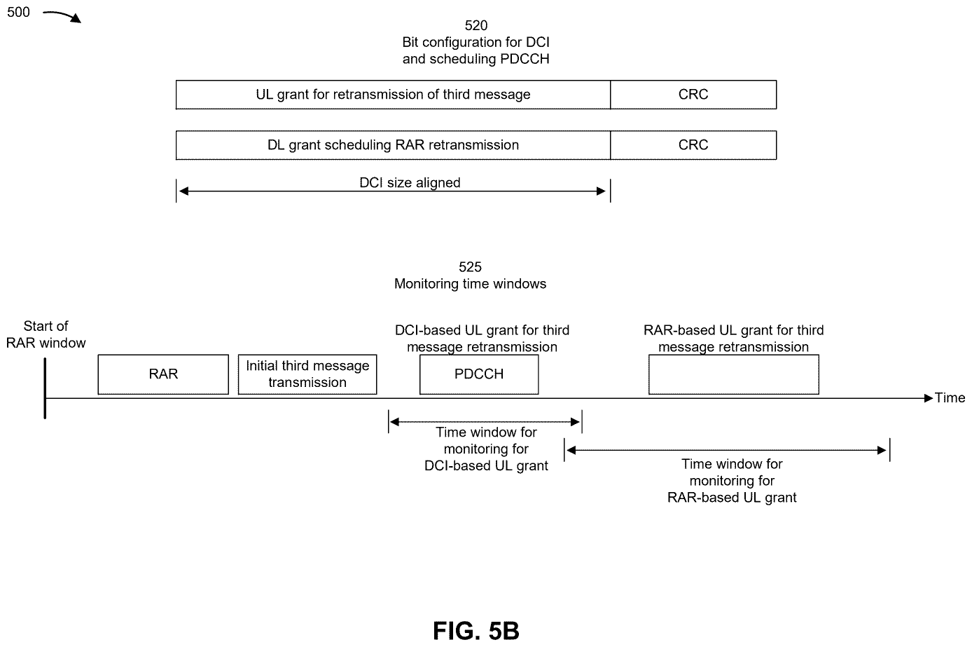

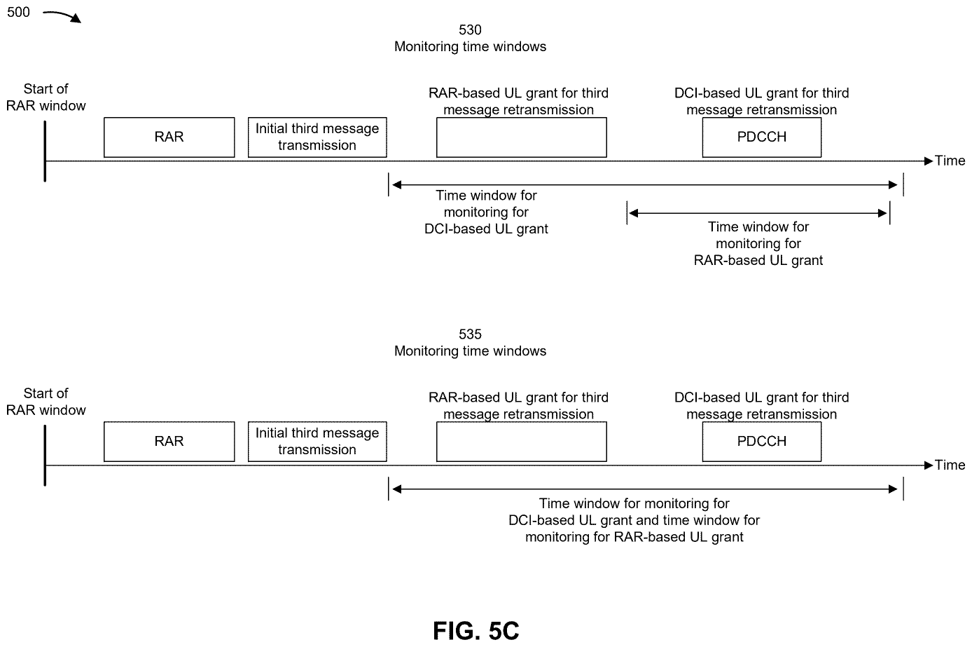

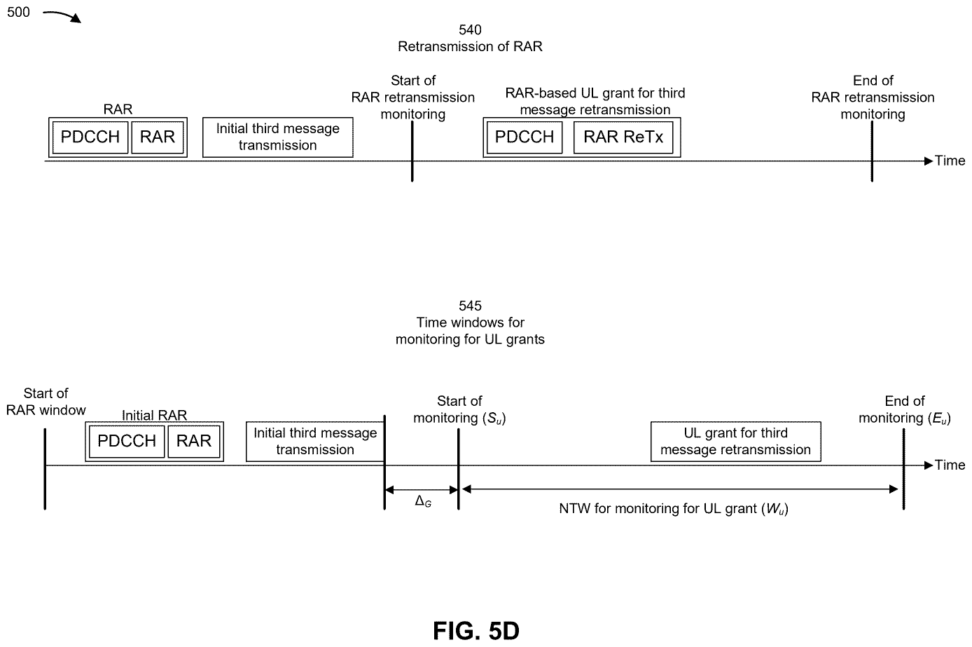

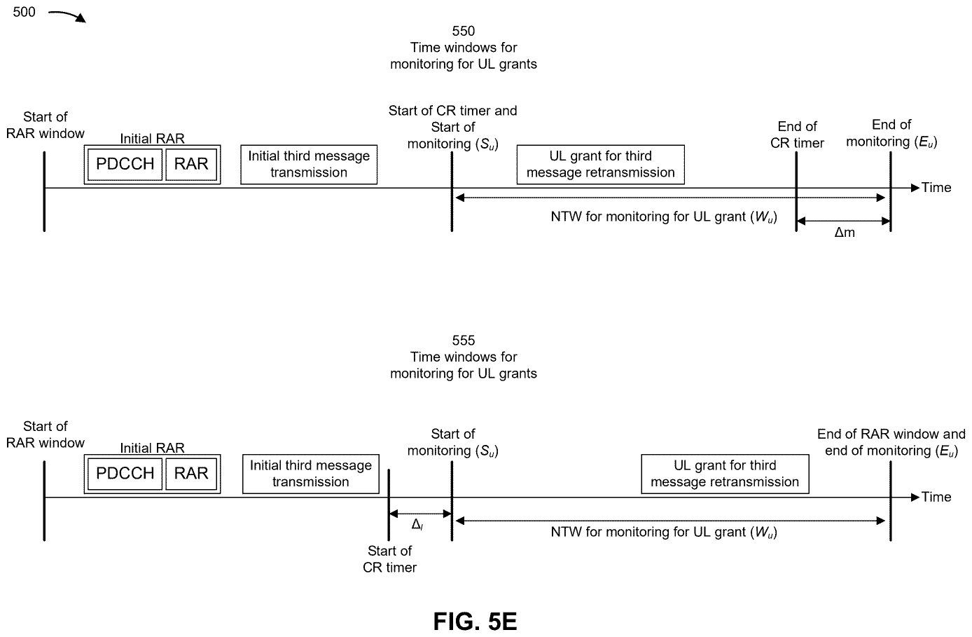

FIGS. 5A-5E are diagrams illustrating an example 500 associated with message retransmission in CBRA procedures. As shown in FIGS. 5A-5E, a network node (e.g., network node 110) and a UE (e.g., UE 120) may communicate with one another.

As shown by FIG. 5A, and reference number 505, a UE may transmit (e.g., using communication manager 150), and a network node may receive (e.g., using communication manager 155), a message related to a CBRA procedure. For example, in a four-step CBRA procedure, this message may be referred to as a third message or a msg3, and in a two-step CBRA procedure, this message may be transmitted in response to a fallback indication (e.g., in response to a msgB). For example, the UE may transmit the third message as part of establishing or re-establishing communication with the network node. In some aspects, the transmitted message may include a preamble and other control information related to the CBRA procedure. In some aspects, transmitting the message related to the CBRA procedure may include transmitting the message according to a scheduling configuration. For example, the scheduling configuration may be based on historical data or network conditions previously experienced by the UE.

As further shown by FIG. 5A, and reference number 510, the network node may transmit (e.g., using communication manager 150), and the UE may receive (e.g., using communication manager 155), an indication of an unsuccessful decoding of the message (e.g., the message related to the CBRA procedure). For example, the unsuccessfully decoded message may be a third message, a msg3, or a scheduled transmission, related to a CBRA procedures. For example, the network node may fail to decode the message due to coverage limitations or network interference, among other reasons.

In some aspects, the network node may transmit the indication (e.g., including the UL grant) solely within the RAR. This approach leverages the existing RAR mechanism to provide the scheduling information for the UE to retransmit the message. By consolidating the UL grant within the RAR, the network node can simplify the signaling process and potentially reduce the overhead associated with separate control information transmissions. Additionally, or alternatively, the network node may transmit the indication (e.g., including the UL grant) within both DCI and the RAR. For example, a portion of the UL grant may be transmitted in the DCI, and the remaining portion of the UL grant may be included in the RAR. For example, the DCI portion of the UL grant may include immediate scheduling information, while the RAR portion of the UL grant may provide scheduling information that supplements the DCI portion of the UL grant. This dual-format retransmission strategy provides an additional layer of reliability by ensuring that the UE receives the UL grant through multiple channels. The DCI can provide immediate scheduling information, while the RAR can reinforce or supplement this information, thereby increasing the likelihood of successful message retransmission. The network can provide this configuration information to the UE through system information (SI) or RRC messages. This flexibility enables the network node to adapt the retransmission process based on current network conditions.

In some aspects, the indication may include a UL grant to enable the UE to retransmit the message. For example, the indication received by the UE may include resource allocation and timing information for retransmitting the message. In some aspects, the indication may be received via a separate control channel specifically allocated for retransmission grants. This dedicated control channel may simplify the process of receiving retransmission grants, thereby reducing latency and improving efficiency.

Additionally, or alternatively, the network node may transmit the indication in an RAR retransmission that includes the UL grant for retransmission of the message related to the CBRA procedure. In some aspects, the indication may indicate that the scheduling information for PUSCH and DMRS transmission may be different from the initial transmission of the message, thereby improving coverage for the retransmission of the message related to the CBRA procedure. For example, this scheduling information, transmitted from the network node to the UE, may include various parameters that can be adjusted to improve the reliability and coverage of the retransmission (e.g., compared to the parameters associated with the initial transmission). For example, the network node may adjust a radio resource allocation, which may allocate different frequency resources for the retransmission compared to the initial transmission. Such an adjustment to the radio resource allocation may enable transmission to avoid interference and increase the probability of successful reception at the network node. Additionally, the network node may adjust an MCS to a more robust MCS, which may enhance the error correction capability and increase the probability of successful decoding by the network node. In some aspects, the network node may adjust repetition levels for the retransmission. For example, by increasing the number of repetitions, the network node can increase the probability that the UE's retransmission will be received by the network node in challenging radio conditions. Additionally, the network node may adjust frequency hopping information to enable the UE to retransmit the message over different frequency bands, thereby mitigating the effects of frequency-selective fading and interference.

Furthermore, the network node may adjust a waveform used for the retransmission based on current network conditions. In some aspects, the network node may adjust transmit power information (e.g., power ramping or TPC) in order to increase the signal strength of the retransmission. Additionally, the network node may adjust spatial filters to optimize beamforming and improve signal quality.

Additionally, or alternatively, the network node may adjust a TBS based on an NDI field being enabled and toggled for the RAR retransmission. Alternatively, the network node may disable the NDI field related to the UE's retransmission of the initial message, thereby ensuring that the TBS remains the same for the UE's retransmission of the message (e.g., the same TBS as in the initial transmission of the message). As a result, the retransmission process may be simplified for the UE.

Additionally, or alternatively, receiving the indication of unsuccessful decoding of the message may include the UE receiving multiple UL grants at once, thereby allowing the UE to choose the UL grant based on current network conditions. This flexibility enables the UE to select the most suitable grant for retransmission, improving the chances of successful reception. Additionally, or alternatively, the indication of unsuccessful decoding of the message may include a change in the transmission bandwidth to improve the chances of successful retransmission. For example, adjusting the bandwidth may help accommodate varying network conditions and optimize the retransmission process. Additionally, or alternatively, receiving the indication of unsuccessful decoding of the message may include the UL grant being received through a broadcast message that includes retransmission grants for multiple UEs. Such a broadcast approach can efficiently manage retransmission grants for several UEs simultaneously, enhancing network performance.

In some aspects, the UE may be configured to monitor for the indication (e.g., including UL grants) with different formats in the same or different time windows after the initial transmission of the message related to the CBRA procedure. Such a configuration provides multiple opportunities for the UE to receive the UL grant for retransmission, thereby increasing the likelihood of successful communication.

In some aspects, the UE may be configured to monitor for UL grants in various formats, such as those transmitted via DCI or RAR retransmissions. By diversifying the formats of UL grants, the network can leverage different signaling mechanisms to increase the probability that the UE receives the retransmission grant. For example, this flexibility in monitoring configurations helps to mitigate issues such as interference, fading, and other factors that may affect the reliability of a single format.

In some aspects, the time windows for monitoring the UL grant can be configured to either align with an existing RAR window or extend beyond the existing RAR window. Aligning the end of the monitoring time windows with the RAR window allows the UE to monitor for UL grants within the same timeframe as the initial RAR. This approach may simplify the monitoring process and reduce the complexity for the UE. However, extending the monitoring time windows beyond the RAR window provides additional opportunities for the UE to receive the UL grant, thereby enhancing the robustness of the retransmission process.

As shown by reference number 515, the UE may retransmit (e.g., using communication manager 150), and the network node may receive (e.g., using communication manager 155), the message related to the CBRA procedure, according to the UL grant received from the network node. For example, the UE may adjust its transmission parameters, such as timing, frequency, and power levels, based on the UL grant to increase the probability of successful reception and decoding by the network node. In some aspects, the retransmitted message may contain the same payload information as the initial transmission, but with enhanced coverage and reliability configurations, as indicated by the network node. For example, retransmitting the message related to the CBRA procedure may include the UE retransmitting the message using a different MCS to increase the probability of the data being successfully decoded (e.g., in adverse channel conditions).

Additionally, or alternatively, retransmitting the message related to the CBRA procedure may include the UE using beamforming techniques to focus the transmission towards the network node for better reception. Beamforming may direct the signal more precisely, reducing interference and improving reception quality. Additionally, or alternatively, retransmitting the message related to the CBRA procedure may include the retransmission occurring at a different time slot to avoid collisions with other transmissions. Timing adjustments may allow the retransmitted message to avoid network congestion and ensure a clearer transmission path.

As shown in FIG. 5B, and by reference number 520, a bit configuration for DCI and scheduling PDCCH may be aligned. For example, the bit size for the DCI may be equal to the bit size for the scheduling PDCCH for the RAR retransmission. This alignment in bit size may reduce the monitoring complexity for the UE by ensuring consistency in the format of the UL grant retransmission. For example, the aligned bit sizes may simplify the decoding process, thereby improving efficiency during UL grant retransmissions.

In some aspects, a cyclic redundancy code (CRC) associated with the UL grant for retransmission of the third message (e.g., the message related to the CBRA procedure) may be masked by a single UE identifier (ID) (e.g., a temporary cell RNTI (TC-RNTI)). Additionally, a CRC associated with the DL grant scheduling the RAR retransmission may be masked by a UE group ID (e.g., a RA-RNTI or a msgB-RNTI, among other examples). Additionally, or alternatively, the bit configuration alignment between DCI and scheduling PDCCH may reduce processing delays. For example, where the bit sizes of the DCI and the RAR are aligned, the UE may experience less processing overhead, thereby improving response times for UL grant retransmissions. Additionally, or alternatively, the uniformity in bit size may help reduce decoding errors and improve the overall reliability of the UL grant retransmission process.

As shown by reference number 525, a UE may monitor different time windows for UL grant retransmissions. For example, the UE may monitor a time window for a DCI-based UL grant for a message retransmission (e.g., retransmission of the message related to the CBRA procedure) and a separate time window for an RAR-based UL grant for the message retransmission. In some aspects, these time windows may fully or partially overlap. This configuration enables the UE to receive the UL grant in a timely manner, even in coverage-limited or high-interference scenarios, thereby improving the reliability of the message retransmission process.

In some aspects, the time window for monitoring the DCI-based UL grant may be scheduled earlier in a timeline relative to the time window for monitoring for the RAR-based UL grant. As a result, the UE may conserve monitoring resources (e.g., processing resources, power resources) by terminating monitoring for the DCI-based UL grant relatively early in the timeline, while the UE may continue to monitor for the RAR-based UL grant.

As shown by reference number 530, the UE may monitor different, partially-overlapping time windows for UL grant retransmissions. For example, the UE may monitor time windows for receiving a UL grant for a message retransmission (e.g., retransmission of a message related to the CBRA procedure) based on an RAR and DCI. In some aspects, the UE may monitor a time window for an RAR-based UL grant for the retransmission of the message related to the CBRA procedure. For example, the UE may monitor this time window after the initial message transmission (e.g., a third message, related to the CBRA procedure), which follows the reception of an initial RAR. In some aspects, the UE may begin monitoring for a DCI-based UL grant at a relatively later time than the UE begins monitoring for the RAR-based UL grant. In other words, the time window for monitoring for the DCI-based UL grant may begin later than the time window for monitoring for the RAR-based UL grant.

In some aspects, the time window for monitoring for the DCI-based UL grant may be associated with a PDCCH communication. The UE may monitor this time window to receive scheduling information for the retransmission of the message related to the CBRA procedure (e.g., a third message). In some aspects, the UE may monitor overlapping time windows to receive one or more UL grants related to the CBRA procedure, ensuring timely reception of scheduling information for message retransmission.

As shown by reference number 535, the UE may monitor a time window for an RAR-based UL grant, and a time window for a DCI-based UL grant, for the retransmission of the message related to the CBRA procedure, where both time windows fully overlap. For example, the UE may monitor this time window after the initial transmission of the message related to the CBRA procedure. In some aspects, where the time window for monitoring for the RAR-based UL grant fully overlaps with the time window for monitoring for the DCI-based UL grant, there is an increased probability that the UE will receive the UL grant and there is increased flexibility as to the time period in which the network node may transmit, to the UE, the RAR-based UL grant or the DCI-based UL grant.

In some aspects, the overlapping time windows for monitoring for the DCI-based UL grant and the RAR-based UL grant provide the network node with flexibility to include the indication (e.g., including a portion of the UL grant) in DCI in a situation in which the RAR payload size is limited. For example, the time windows for monitoring for DCI-based and RAR-based UL grants may fully overlap, allowing the UE to simultaneously monitor both formats within the same timeframe. This overlapping configuration can increase the probability of the UE receiving the UL grant, as it can capture the grant from either format without missing any opportunities.

As shown in FIG. 5D, and by reference number 540, a network node may transmit, and a UE may receive, a retransmission of an RAR. For example, the retransmission of the RAR may include a UL grant for the UE to retransmit a third message (e.g., a msg3) related to a CBRA procedure. This retransmission enables the UE to attempt communication again where the initial third message transmission not successfully decoded by the network node.

For example, after the initial third message transmission (e.g., the message related to the CBRA procedure), the UE may be configured to monitor for a retransmitted RAR-based UL grant for retransmitting the third message. Because the UE's PRACH preamble has been successfully detected by the network node, the UE may be configured to monitor the same group RNTI (e.g., RA-RNTI, msgB-RNTI) for the RAR retransmission. Such a configuration enables the UE to accurately identify the retransmitted RAR and respond accordingly. The group RNTI may serve as an identifier that links the retransmission to the initial random access attempt, maintaining continuity in the communication process.

In addition to monitoring the same group RNTI, the UE may also expect to receive the same random access preamble identifier (RAPID), timing advance (TA) command, and UE ID (e.g., TC-RNTI) as in the initial or previous RAR. The RAPID may enable the UE to recognize that the retransmission is associated with its initial preamble (e.g., for the initial transmission of the third message related to the CBRA procedure). The TA command may enable the UE's subsequent transmissions to be synchronized with the network's timing configuration. The UE ID (e.g., a TC-RNTI), may uniquely identify the UE within the cell, allowing the network node to manage multiple UEs efficiently. Additionally, the PDCCH associated with the initial RAR and the PDCCH associated with the retransmission of the RAR may include a CRC that is masked by the same group RNTI. By receiving these consistent identifiers and commands, the UE may be enabled to continue the random access procedure and retransmit the third message with adjustments for improved reliability.

As shown by reference numbers 545, 550, and 555, a UE may transmit an initial third message transmission (e.g., a msg3) related to a CBRA procedure. For example, the initial third message transmission may be part of the UE's attempt to establish or re-establish communication with the network node. The network node, upon detecting an unsuccessful decoding of the initial third message transmission, may retransmit a UL grant for the third message retransmission. In some aspects, the UE may be configured such that the time window for monitoring for an RAR retransmission may extend beyond a time window associated with the initial RAR transmission.

In some aspects, after the initial transmission of a third message (e.g., msg3) related to a CBRA procedure, the UE may be configured to monitor for a UL grant (e.g., for retransmission of the third message) in a new time window (NTW). In some aspects, the NTW may be distinct from an initial RAR window, providing the UE with additional flexibility and opportunities to receive the UL grant. In some aspects, the UE may re-use the configuration of the CR timer for the NTW, ensuring a seamless transition and minimizing the use of additional configuration steps. Additionally, in some aspects, the received UL grant can be based on either an RAR or DCI.

However, the network node may indicate a different NTW configuration to the UE, particularly in scenarios where it is beneficial to reduce the time duration of monitoring for RAR retransmissions, thereby saving power and processing resources. Using a different NTW configuration may allow the network node to optimize the monitoring period based on current network conditions and requirements, thereby enhancing the efficiency and reliability of the message retransmission process. The ability to configure the NTW differently from the CR timer provides the network with greater control over the retransmission process, ensuring that the UE remains synchronized with the network's scheduling and resource allocation strategies.

As shown by reference number 545, where the NTW configuration is different from the CR timer, the start and end of the NTW may be determined based on one or more conditions. In some aspects, the start of the NTW (e.g., Sᵤ) may be determined according to a threshold quantity of symbols (e.g., Δ_{G}) with respect to a last UL symbol of the initial third message (e.g., msg3) transmission related to a CBRA procedure. This approach provides a configured time interval between the end of the initial third message transmission and the beginning of the NTW, allowing the network to process the initial transmission and prepare for the potential retransmission. The threshold time period prevents any overlap or interference between the initial transmission and the monitoring period for the UL grant, thereby enhancing the reliability of the retransmission process.

Furthermore, the end of the NTW (e.g., Eᵤ) may be determined according to a time duration (e.g., Wᵤ) with respect to the start of the time window (e.g., Sᵤ). This configuration provides a period during which the UE is expected to monitor for the UL grant for a third message retransmission, thereby enabling the UE to monitor for a UL grant, while also managing the UE's power consumption and resource allocation. This approach allows for a flexible and efficient monitoring period, tailored to the network node or the UE, thereby improving the overall performance and reliability of the CBRA procedure.

As shown in FIG. 5E, and by reference number 550, where the NTW configuration is different from the CR timer, the start and end of the NTW may be determined based on one or more conditions. In some aspects, the start of the NTW (e.g., Sᵤ) may be aligned with a start of the CR timer. Additionally, the end of the NTW (e.g., Eᵤ) may be determined according to an offset (e.g., Δₘ) of symbols or slots with respect to the end of the CR timer. For example, by configuring the end of the NTW based on an offset from the CR timer, the network node can optimize the monitoring period to balance resource utilization and power consumption.

As shown by reference number 555, where the NTW configuration is different from the CR timer, the start of the NTW (e.g., Sᵤ) may be determined according to an offset (e.g., Δₗ) of symbols or slots with respect to the start of the CR timer. Additionally, the end of the NTW (e.g., Eᵤ) may be determined according to an offset (e.g., Δₑₓₜ) of slots or symbols with respect to the end of an RAR window. This configuration allows for a flexible monitoring period that can be tailored to network conditions, enabling the UE to effectively monitor for UL grants while optimizing resource utilization and power consumption.

Additionally, or alternatively, the UE may start a CR timer after transmission of the third message (e.g., msg3), related to a CBRA procedure, and the UE may restart the CR timer after retransmission of the third message (e.g., based on a UL grant received via an RAR or DCI, or via the RAR and DCI). In some aspects, the UE may terminate an initial RAR window after decoding the RAR that schedules the transmission of the third message, or after starting the NTW for monitoring for a UL grant for retransmitting the third message. Where the CR timer fully or partially overlaps with the NTW (e.g., Sᵤ, Eᵤ), the UE may monitor multiple DCIs after the transmission or retransmission of the third message, including DCI scheduling RAR retransmission, DCI scheduling a fourth message (e.g., a message transmitted from the network node, to the UE, after the network node successfully decodes a third message), or DCI scheduling retransmission of the third message.

Additionally, where the UE decodes the fourth message (e.g., PDSCH) before receiving or decoding DCI that schedules retransmission of the RAR or the third message, the UE may stop monitoring for or decoding DCI that schedules retransmission of the RAR or the third message, and the UE may terminate a CR timer or a NTW. In some aspects, where the UE decodes the RAR retransmission (e.g., PDSCH) before receiving or decoding a fourth message or DCI that schedules retransmission of the third message, the UE may stop monitoring for or decoding DCI that schedules the fourth message or retransmission of the third message, and the UE may terminate the CR timer or the NTW. In some aspects, where the UE decodes DCI that schedules retransmission of the third message before receiving or decoding DCI that schedules the fourth message or retransmission of the RAR, the UE may stop monitoring for or decoding DCI that schedules the fourth message or retransmission of the RAR, and the UE may terminate the CR timer or the NTW. As a result, the UE's monitoring procedures may be simplified, thereby conserving power by avoiding unnecessary monitoring, and resolving potential ambiguities in the implementation of the retransmission process. For example, where the UE is configured with conditions under which the UE can stop monitoring for DCI, the efficiency and reliability of the CBRA procedure may be improved, enhanced better resource utilization and more flexible performance in varying network conditions.

As described herein, by enabling the UE to monitor for different types of UL grants and adjusting the monitoring period for these grants, the UE may improve the reliability and efficiency of message retransmissions in CBRA procedures. In some aspects, if the initial message transmission is unsuccessfully decoded by the network node, the network node may resend the UL grant to enable the UE to retransmit the initial message. This UL grant can be retransmitted either in an RAR only or in both DCI and RAR (e.g., a portion of the UL grant may be transmitted in DCI and a portion of the UL grant may be transmitted in an RAR). In some aspects, the UE can be configured to monitor UL grants with different formats in the same or different time windows, which may fully or partially overlap. Such a configuration can extend the UE's monitoring beyond an initial RAR window (e.g., associated with receipt of the initial RAR), enabling the UE to receive retransmission UL grants more reliably. The starting and ending points of these monitoring windows may also be adjusted according to one or more parameters or thresholds. For example, a starting or ending point of a monitoring window may align with, or be offset from, a CR timer related to the CBRA procedure. Additionally, in some aspects, the RAR retransmission may be adapted to include different scheduling information for the UE's retransmission of the initial message (e.g., the unsuccessfully decoded message).

Where the UE is configured to monitor multiple UL grant formats and to adapt the associated monitoring period, the reliability of message retransmission may be improved in CBRA procedures (e.g., in coverage-limited scenarios, in scenarios of relatively high network interference levels, or the like). In this way, the UE and the network node may reduce the likelihood of failed message retransmissions and subsequent delays in the CBRA procedure, which may conserve processing resources and network resources. Additionally, by aligning the DCI size and configuring overlapping monitoring windows, the configuration complexity associated with monitoring for a UL grant may be reduced, leading to more efficient resource utilization and lower power consumption. Furthermore, by enhancing the contents of RAR retransmissions and indicating monitoring configurations for the UE, the overall latency performance and communication efficiency during CBRA procedures may be improved.

As indicated above, FIGS. 5A-5E are provided as an example. Other examples may differ from what is described with respect to FIG. 5A-5E.

FIG. 6 is a diagram illustrating an example process 600 performed, for example, at a UE or an apparatus of a UE. Example process 600 is an example where the apparatus or the UE (e.g., UE 120) performs operations associated with message retransmission in CBRA procedures.

As shown in FIG. 6, in some aspects, process 600 may include transmitting, to a network node, a message, related to a CBRA procedure, according to a schedule indicated by an RAR (block 610). For example, the UE (e.g., using transmission component 804 or communication manager 806, depicted in FIG. 8) may transmit, to a network node, a message, related to a CBRA procedure, according to a schedule indicated by an RAR, as described above.

As further shown in FIG. 6, in some aspects, process 600 may include receiving, from the network node, an indication of an unsuccessful decoding of the message, wherein the indication includes a UL grant for retransmission of the message (block 620). For example, the UE (e.g., using reception component 802 or communication manager 806, depicted in FIG. 8) may receive, from the network node, an indication of an unsuccessful decoding of the message, wherein the indication includes a UL grant for retransmission of the message, as described above.

As further shown in FIG. 6, in some aspects, process 600 may include retransmitting, to the network node, the message, according to the UL grant (block 630). For example, the UE (e.g., using transmission component 804 or communication manager 806, depicted in FIG. 8) may retransmit, to the network node, the message, according to the UL grant, as described above.

Process 600 may include additional aspects, such as any single aspect or any combination of aspects described below or in connection with one or more other processes described elsewhere herein.

In a first aspect, a first portion of the UL grant is received within DCI and a second portion of the UL grant is received within an RAR retransmission.

In a second aspect, alone or in combination with the first aspect, a bit size for the DCI is equal to a bit size for a scheduling physical downlink control channel for the RAR retransmission.

In a third aspect, alone or in combination with one or more of the first and second aspects, process 600 includes monitoring a first time window and a second time window for the indication, according to a monitoring configuration, where the first time window is associated with a DCI transmission format and the second time window is associated with an RAR retransmission format.

In a fourth aspect, alone or in combination with one or more of the first through third aspects, the first time window and the second time window fully overlap.

In a fifth aspect, alone or in combination with one or more of the first through fourth aspects, the first time window and the second time window partially overlap.

In a sixth aspect, alone or in combination with one or more of the first through fifth aspects, the first time window and the second time window do not overlap.

In a seventh aspect, alone or in combination with one or more of the first through sixth aspects, process 600 includes receiving (e.g., using reception component 802 or communication manager 806, depicted in FIG. 8), from the network node prior to receiving the indication, configuration information that indicates one or more UL grant formats supported by the network node.

In an eighth aspect, alone or in combination with one or more of the first through seventh aspects, the transmission of the message is according to a first set of scheduling information and the retransmission of the message is according to a second set of scheduling information.

In a ninth aspect, alone or in combination with one or more of the first through eighth aspects, each of the first set of scheduling information and the second set of scheduling information indicates one or more of a radio resource allocation, a modulation and coding scheme, a set of repetition levels, frequency hopping information, waveform information, transmit power information, spatial filter information, or a transport block size.

In a tenth aspect, alone or in combination with one or more of the first through ninth aspects, the first set of scheduling information indicates a first transport block size, and the second set of scheduling information indicates a second transport block size, different from the first transport block size, based on a determination that a new data indicator, included in the indication, is enabled and toggled.

In an eleventh aspect, alone or in combination with one or more of the first through tenth aspects, the transmission of the message and the retransmission of the message are associated with a same transport block size, based on a determination that a new data indicator, included in the indication, is disabled.

In a twelfth aspect, alone or in combination with one or more of the first through eleventh aspects, the indication is received in an RAR retransmission.

In a thirteenth aspect, alone or in combination with one or more of the first through twelfth aspects, the RAR retransmission and the RAR are both associated with a group radio network temporary identifier.

In a fourteenth aspect, alone or in combination with one or more of the first through thirteenth aspects, the RAR retransmission and the RAR are both associated with a random access preamble identifier, a timing advance command, and a UE identifier.

In a fifteenth aspect, alone or in combination with one or more of the first through fourteenth aspects, process 600 includes monitoring, prior to receiving the indication from the network node, for receipt of the indication in an NTW, where the NTW is different from an initial time window associated with the RAR.

In a sixteenth aspect, alone or in combination with one or more of the first through fifteenth aspects, a start of the NTW is aligned with a start of a CR timer related to the CBRA procedure.

In a seventeenth aspect, alone or in combination with one or more of the first through sixteenth aspects, a start of the NTW is based on a threshold quantity of symbols occurring after a final UL symbol of the transmission of the message.

In an eighteenth aspect, alone or in combination with one or more of the first through seventeenth aspects, a start of the NTW is based on an offset applied to a start of a CR timer related to the CBRA procedure.

In a nineteenth aspect, alone or in combination with one or more of the first through eighteenth aspects, an end of the NTW is based on an offset applied to an end of a CR timer related to the CBRA procedure.

In a twentieth aspect, alone or in combination with one or more of the first through nineteenth aspects, an end of the NTW is based on an offset applied to an end of the initial time window.

In a twenty-first aspect, alone or in combination with one or more of the first through twentieth aspects, an end of the NTW is based on a threshold time duration after a start of the NTW.

In a twenty-second aspect, alone or in combination with one or more of the first through twenty-first aspects, process 600 includes terminating the initial time window based on a determination that the UE has initiated monitoring for receipt of the indication, in the NTW.

In a twenty-third aspect, alone or in combination with one or more of the first through twenty-second aspects, process 600 includes starting a CR timer, associated with the CBRA procedure, after the transmission of the message, and restarting the CR timer, associated with the CBRA procedure, after the retransmission of the message.

In a twenty-fourth aspect, alone or in combination with one or more of the first through twenty-third aspects, process 600 includes terminating monitoring for receipt of the RAR, in an initial time window associated with the RAR, based on the UE successfully decoding the schedule indicated by the RAR.

In a twenty-fifth aspect, alone or in combination with one or more of the first through twenty-fourth aspects, process 600 includes monitoring for a set of DCI transmissions, based on a determination of an overlap between a CR timer, related to the CBRA procedure, and an NTW associated with monitoring for receipt of the indication.

In a twenty-sixth aspect, alone or in combination with one or more of the first through twenty-fifth aspects, the set of DCI transmissions includes first DCI that indicates scheduling of a retransmission of the RAR, second DCI that indicates scheduling a transmission of an additional message related to the CBRA procedure, and third DCI that indicates scheduling of the retransmission of the message.

In a twenty-seventh aspect, alone or in combination with one or more of the first through twenty-sixth aspects, process 600 includes receiving (e.g., using reception component 802 or communication manager 806, depicted in FIG. 8) the first DCI, receiving, from the network node, the retransmission of the RAR according to the scheduling of the retransmission of the RAR indicated in the first DCI, and terminating a CR timer, related to the CBRA procedure, and an NTW, related to monitoring for receipt of the indication, based on a successful decoding of the retransmission of the RAR prior to receiving the second DCI or the third DCI.

In a twenty-eighth aspect, alone or in combination with one or more of the first through twenty-seventh aspects, process 600 includes receiving (e.g., using reception component 802 or communication manager 806, depicted in FIG. 8) the third DCI, where the third DCI includes the indication, and terminating a CR timer, related to the CBRA procedure, and an NTW, related to monitoring for receipt of the indication, based on a successful decoding of the third DCI prior to receiving the first DCI or the second DCI.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with message retransmission in CBRA procedures.

As shown in FIG. 7, in some aspects, process 700 may include receiving, from a UE, a message, related to a CBRA procedure (block 710). For example, the network node (e.g., using reception component 902 or communication manager 906, depicted in FIG. 9) may receive, from a UE, a message, related to a CBRA procedure, as described above.

As further shown in FIG. 7, in some aspects, process 700 may include transmitting, to the UE, an indication of an unsuccessful decoding of the message, wherein the indication includes a UL grant for retransmission of the message (block 720). For example, the network node (e.g., using transmission component 904 or communication manager 906, depicted in FIG. 9) may transmit, to the UE, an indication of an unsuccessful decoding of the message, wherein the indication includes a UL grant for retransmission of the message, as described above.

As further shown in FIG. 7, in some aspects, process 700 may include receiving, from the UE, a retransmission of the message, according to the UL grant (block 730). For example, the network node (e.g., using reception component 902 or communication manager 906, depicted in FIG. 9) may receive, from the UE, a retransmission of the message, according to the UL grant, as described above.

Process 700 may include additional aspects, such as any single aspect or any combination of aspects described below or in connection with one or more other processes described elsewhere herein.

In a first aspect, the UL grant is transmitted in an RAR retransmission.

In a second aspect, alone or in combination with the first aspect, a first portion of the UL grant is transmitted within DCI and a second portion of the UL grant is transmitted within an RAR retransmission.

In a third aspect, alone or in combination with one or more of the first and second aspects, a bit size for the DCI is equal to a bit size for a scheduling physical downlink control channel for the RAR retransmission.

In a fourth aspect, alone or in combination with one or more of the first through third aspects, process 700 includes transmitting (e.g., using transmission component 904 or communication manager 906, depicted in FIG. 9), to the UE prior to transmitting the indication, configuration information that indicates one or more UL grant formats supported by the network node.

In a fifth aspect, alone or in combination with one or more of the first through fourth aspects, the indication is transmitted in an RAR retransmission.

In a sixth aspect, alone or in combination with one or more of the first through fifth aspects, the RAR retransmission and an RAR are both associated with a group radio network temporary identifier.

In a seventh aspect, alone or in combination with one or more of the first through sixth aspects, the RAR retransmission and an RAR are both associated with a random access preamble identifier, a timing advance command, and a UE identifier.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 5A-5E. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit, to a network node, a message, related to a CBRA procedure, according to a schedule indicated by an RAR. The reception component 802 may receive, from the network node, an indication of an unsuccessful decoding of the message, wherein the indication includes a UL grant for retransmission of the message. The transmission component 804 may retransmit, to the network node, the message, according to the UL grant.

The communication manager 806 may monitor a first time window and a second time window for the indication, according to a monitoring configuration, wherein the first time window is associated with a DCI transmission format and the second time window is associated with an RAR retransmission format.

The reception component 802 may receive, from the network node prior to receiving the indication, configuration information that indicates one or more UL grant formats supported by the network node.

The communication manager 806 may monitor, prior to receiving the indication from the network node, for receipt of the indication in an NTW, wherein the NTW is different from an initial time window associated with the RAR.

The communication manager 806 may terminate the initial time window based on a determination that the UE has initiated monitoring for receipt of the indication, in the NTW.

The communication manager 806 may start a CR timer, associated with the CBRA procedure, after the transmission of the message.

The communication manager 806 may restart the CR timer, associated with the CBRA procedure, after the retransmission of the message.

The communication manager 806 may terminate monitoring for receipt of the RAR, in an initial time window associated with the RAR, based on the UE successfully decoding the schedule indicated by the RAR.

The communication manager 806 may monitor for a set of DCI transmissions, based on a determination of an overlap between a CR timer, related to the CBRA procedure, and an NTW associated with monitoring for receipt of the indication.

The reception component 802 may receive the first DCI.

The reception component 802 may receive, from the network node, the retransmission of the RAR according to the scheduling of the retransmission of the RAR indicated in the first DCI.

The communication manager 806 may terminate a CR timer, related to the CBRA procedure, and an NTW, related to monitoring for receipt of the indication, based on a successful decoding of the retransmission of the RAR prior to receiving the second DCI or the third DCI.

The reception component 802 may receive the third DCI, wherein the third DCI includes the indication.

The communication manager 806 may terminate a CR timer, related to the CBRA procedure, and an NTW, related to monitoring for receipt of the indication, based on a successful decoding of the third DCI prior to receiving the first DCI or the second DCI.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 5A-5E. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive, from a UE, a message, related to a CBRA procedure. The transmission component 904 may transmit, to the UE, an indication of an unsuccessful decoding of the message, wherein the indication includes a UL grant for retransmission of the message. The reception component 902 may receive, from the UE, a retransmission of the message, according to the UL grant.

The transmission component 904 may transmit, to the UE prior to transmitting the indication, configuration information that indicates one or more UL grant formats supported by the network node.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: transmitting, to a network node, a message, related to a contention-based random access procedure, according to a schedule indicated by a random access response (RAR); receiving, from the network node, an indication of an unsuccessful decoding of the message, wherein the indication includes an uplink (UL) grant for retransmission of the message; and retransmitting, to the network node, the message, according to the UL grant.
Aspect 2: The method of Aspect 1, wherein a first portion of the UL grant is received within downlink control information (DCI) and a second portion of the UL grant is received within an RAR retransmission.
Aspect 3: The method of Aspect 2, wherein a bit size for the DCI is equal to a bit size for a scheduling physical downlink control channel for the RAR retransmission.
Aspect 4: The method of Aspect 2, further comprising: monitoring a first time window and a second time window for the indication, according to a monitoring configuration, wherein the first time window is associated with a DCI transmission format and the second time window is associated with an RAR retransmission format.
Aspect 5: The method of Aspect 4, wherein the first time window and the second time window fully overlap.
Aspect 6: The method of Aspect 4, wherein the first time window and the second time window partially overlap.
Aspect 7: The method of Aspect 4, wherein the first time window and the second time window do not overlap.
Aspect 8: The method of any of Aspects 1-7, further comprising: receiving, from the network node prior to receiving the indication, configuration information that indicates one or more UL grant formats supported by the network node.
Aspect 9: The method of any of Aspects 1-8, wherein the transmission of the message is according to a first set of scheduling information and the retransmission of the message is according to a second set of scheduling information.
Aspect 10: The method of Aspect 9, wherein each of the first set of scheduling information and the second set of scheduling information indicates one or more of: a radio resource allocation, a modulation and coding scheme, a set of repetition levels, frequency hopping information, waveform information, transmit power information, spatial filter information, or a transport block size.
Aspect 11: The method of Aspect 9, wherein the first set of scheduling information indicates a first transport block size, and wherein the second set of scheduling information indicates a second transport block size, different from the first transport block size, based on a determination that a new data indicator, included in the indication, is enabled and toggled.
Aspect 12: The method of Aspect 9, wherein the transmission of the message and the retransmission of the message are associated with a same transport block size, based on a determination that a new data indicator, included in the indication, is disabled.
Aspect 13: The method of any of Aspects 1-12, wherein the indication is received in an RAR retransmission.
Aspect 14: The method of Aspect 13, wherein the RAR retransmission and the RAR are both associated with a group radio network temporary identifier.
Aspect 15: The method of Aspect 13, wherein the RAR retransmission and the RAR are both associated with a random access preamble identifier, a timing advance command, and a UE identifier.
Aspect 16: The method of any of Aspects 1-15, further comprising: monitoring, prior to receiving the indication from the network node, for receipt of the indication in a new time window (NTW), wherein the NTW is different from an initial time window associated with the RAR.
Aspect 17: The method of Aspect 16, wherein a start of the NTW is aligned with a start of a contention resolution timer related to the contention-based random access procedure.
Aspect 18: The method of Aspect 16, wherein a start of the NTW is based on a threshold quantity of symbols occurring after a final UL symbol of the transmission of the message.
Aspect 19: The method of Aspect 16, wherein a start of the NTW is based on an offset applied to a start of a contention resolution timer related to the contention-based random access procedure.
Aspect 20: The method of Aspect 16, wherein an end of the NTW is based on an offset applied to an end of a contention resolution timer related to the contention-based random access procedure.
Aspect 21: The method of Aspect 16, wherein an end of the NTW is based on an offset applied to an end of the initial time window.
Aspect 22: The method of Aspect 16, wherein an end of the NTW is based on a threshold time duration after a start of the NTW.
Aspect 23: The method of Aspect 16, further comprising: terminating the initial time window based on a determination that the UE has initiated monitoring for receipt of the indication, in the NTW.
Aspect 24: The method of any of Aspects 1-23, further comprising: starting a contention resolution timer, associated with the contention-based random access procedure, after the transmission of the message; and restarting the contention resolution timer, associated with the contention-based random access procedure, after the retransmission of the message.
Aspect 25: The method of any of Aspects 1-24, further comprising: terminating monitoring for receipt of the RAR, in an initial time window associated with the RAR, based on the UE successfully decoding the schedule indicated by the RAR.
Aspect 26: The method of any of Aspects 1-25, further comprising: monitoring for a set of downlink control information (DCI) transmissions, based on a determination of an overlap between a contention resolution timer, related to the contention-based random access procedure, and a new time window (NTW) associated with monitoring for receipt of the indication.
Aspect 27: The method of Aspect 26, wherein the set of DCI transmissions includes first DCI that indicates scheduling of a retransmission of the RAR, second DCI that indicates scheduling a transmission of an additional message related to the contention-based random access procedure, and third DCI that indicates scheduling of the retransmission of the message.
Aspect 28: The method of Aspect 27, further comprising: receiving the first DCI; receiving, from the network node, the retransmission of the RAR according to the scheduling of the retransmission of the RAR indicated in the first DCI; and terminating a contention resolution timer, related to the contention-based random access procedure, and a new time window, related to monitoring for receipt of the indication, based on a successful decoding of the retransmission of the RAR prior to receiving the second DCI or the third DCI.
Aspect 29: The method of Aspect 27, further comprising: receiving the third DCI, wherein the third DCI includes the indication; and terminating a contention resolution timer, related to the contention-based random access procedure, and a new time window, related to monitoring for receipt of the indication, based on a successful decoding of the third DCI prior to receiving the first DCI or the second DCI.
Aspect 30: A method of wireless communication performed by a network node, comprising: receiving, from a user equipment (UE), a message, related to a contention-based random access procedure; transmitting, to the UE, an indication of an unsuccessful decoding of the message, wherein the indication includes an uplink (UL) grant for retransmission of the message; and receiving, from the UE, a retransmission of the message, according to the UL grant.
Aspect 31: The method of Aspect 30, wherein the UL grant is transmitted in a random access response (RAR) retransmission.
Aspect 32: The method of any of Aspects 30-31, wherein a first portion of the UL grant is transmitted within downlink control information (DCI) and a second portion of the UL grant is transmitted within a random access response (RAR) retransmission.
Aspect 33: The method of Aspect 32, wherein a bit size for the DCI is equal to a bit size for a scheduling physical downlink control channel for the RAR retransmission.
Aspect 34: The method of any of Aspects 30-33, further comprising: transmitting, to the UE prior to transmitting the indication, configuration information that indicates one or more UL grant formats supported by the network node.
Aspect 35: The method of any of Aspects 30-34, wherein the indication is transmitted in a random access response (RAR) retransmission.
Aspect 36: The method of Aspect 35, wherein the RAR retransmission and an RAR are both associated with a group radio network temporary identifier.
Aspect 37: The method of Aspect 35, wherein the RAR retransmission and an RAR are both associated with a random access preamble identifier, a timing advance command, and a UE identifier.
Aspect 38: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-37.
Aspect 39: An apparatus for wireless communication at a device, the apparatus comprising one or more memories and one or more processors coupled to the one or more memories, the one or more processors configured to cause the device to perform the method of one or more of Aspects 1-37.
Aspect 40: An apparatus for wireless communication, the apparatus comprising at least one means for performing the method of one or more of Aspects 1-37.
Aspect 41: A non-transitory computer-readable medium storing code for wireless communication, the code comprising instructions executable by one or more processors to perform the method of one or more of Aspects 1-37.
Aspect 42: A non-transitory computer-readable medium storing a set of instructions for wireless communication, the set of instructions comprising one or more instructions that, when executed by one or more processors of a device, cause the device to perform the method of one or more of Aspects 1-37.
Aspect 43: A device for wireless communication, the device comprising a processing system that includes one or more processors and one or more memories coupled with the one or more processors, the processing system configured to cause the device to perform the method of one or more of Aspects 1-37.
Aspect 44: An apparatus for wireless communication at a device, the apparatus comprising one or more memories and one or more processors coupled to the one or more memories, the one or more processors individually or collectively configured to cause the device to perform the method of one or more of Aspects 1-37.
Aspect 45: A device comprising a processing system that includes one or more processors and one or more code-storing memories coupled with the one or more processors, the processing system configured to cause the device to perform the method of one or more of Aspects 1-37.
Aspect 46: A device comprising a processing system that includes processor circuitry and code-storing memory circuitry, the processing system configured to cause the device to perform the method of one or more of Aspects 1-37.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, to a network node, a message, related to a contention-based random access procedure, according to a schedule indicated by a random access response (RAR);
receive, from the network node, an indication of an unsuccessful decoding of the message, wherein the indication includes an uplink (UL) grant for retransmission of the message; and
retransmit, to the network node, the message, according to the UL grant.

2. The UE of claim 1, wherein a first portion of the UL grant is received within downlink control information (DCI) and a second portion of the UL grant is received within an RAR retransmission.

3. The UE of claim 2, wherein the processing system is configured to cause the UE to:
monitor a first time window and a second time window for the indication, according to a monitoring configuration, wherein the first time window is associated with a DCI transmission format and the second time window is associated with an RAR retransmission format.

4. The UE of claim 1, wherein the processing system is configured to cause the UE to:
receive, from the network node prior to receiving the indication, configuration information that indicates one or more UL grant formats supported by the network node.

5. The UE of claim 1, wherein the transmission of the message is according to a first set of scheduling information and the retransmission of the message is according to a second set of scheduling information.

6. The UE of claim 1, wherein the indication is received in an RAR retransmission.

7. The UE of claim 1, wherein the processing system is configured to cause the UE to:
monitor, prior to receiving the indication from the network node, for receipt of the indication in a new time window (NTW), wherein the NTW is different from an initial time window associated with the RAR.

8. The UE of claim 1, wherein the processing system is configured to cause the UE to:
start a contention resolution timer, associated with the contention-based random access procedure, after the transmission of the message; and
restart the contention resolution timer, associated with the contention-based random access procedure, after the retransmission of the message.

9. The UE of claim 1, wherein the processing system is configured to cause the UE to:
terminate monitoring for receipt of the RAR, in an initial time window associated with the RAR, based on the UE successfully decoding the schedule indicated by the RAR.

10. The UE of claim 1, wherein the processing system is configured to cause the UE to:
monitor for a set of downlink control information (DCI) transmissions, based on a determination of an overlap between a contention resolution timer, related to the contention-based random access procedure, and a new time window (NTW) associated with monitoring for receipt of the indication.

11. The UE of claim 10, wherein the set of DCI transmissions includes first DCI that indicates scheduling of a retransmission of the RAR, second DCI that indicates scheduling a transmission of an additional message related to the contention-based random access procedure, and third DCI that indicates scheduling of the retransmission of the message.

12. The UE of claim 11, wherein the processing system is configured to cause the UE to:
receive the first DCI;
receive, from the network node, the retransmission of the RAR according to the scheduling of the retransmission of the RAR indicated in the first DCI; and
terminate a contention resolution timer, related to the contention-based random access procedure, and a new time window, related to monitoring for receipt of the indication, based on a successful decoding of the retransmission of the RAR prior to receiving the second DCI or the third DCI.

13. The UE of claim 11, wherein the processing system is configured to cause the UE to:
receive the third DCI, wherein the third DCI includes the indication; and
terminate a contention resolution timer, related to the contention-based random access procedure, and a new time window, related to monitoring for receipt of the indication, based on a successful decoding of the third DCI prior to receiving the first DCI or the second DCI.

14. A network node, comprising:
a processing system that includes one or more processors and one or more code-storing memories coupled with the one or more processors, the processing system configured to cause the network node to:
receive, from a user equipment (UE), a message, related to a contention-based random access procedure;
transmit, to the UE, an indication of an unsuccessful decoding of the message, wherein the indication includes an uplink (UL) grant for retransmission of the message; and
receive, from the UE, a retransmission of the message, according to the UL grant.

15. The network node of claim 14, wherein the UL grant is transmitted in a random access response (RAR) retransmission.

16. The network node of claim 14, wherein a first portion of the UL grant is transmitted within downlink control information (DCI) and a second portion of the UL grant is transmitted within a random access response (RAR) retransmission.

17. The network node of claim 16, wherein a bit size for the DCI is equal to a bit size for a scheduling physical downlink control channel for the RAR retransmission.

18. The network node of claim 14, wherein the processing system is configured to cause the network node to:
transmit, to the UE prior to transmitting the indication, configuration information that indicates one or more UL grant formats supported by the network node.

19. The network node of claim 14, wherein the indication is transmitted in a random access response (RAR) retransmission.

20. A method of wireless communication performed by a user equipment (UE), comprising:
transmitting, to a network node, a message, related to a contention-based random access procedure, according to a schedule indicated by a random access response (RAR);
receiving, from the network node, an indication of an unsuccessful decoding of the message, wherein the indication includes an uplink (UL) grant for retransmission of the message; and
retransmitting, to the network node, the message, according to the UL grant.
